(19) United States
(12) Patent Application Publication
(10) Pub. No.: US 2020/0134650 A1
(43) Pub. Date: Apr. 30, 2020

(54) GROUP MARKETING SYSTEM, GROUP MARKETING DEVICE AND GROUP MARKETING METHOD

(71) Applicant: Institute For Information Industry, Taipei (TW)

(72) Inventors: Yi-Chun CHEN, Taoyuan City (TW); Ming-De SUNG, Taipei City (TW); Yueh-Hsin HSU, Miaoli County (TW); Chih-Ya SHEN, New Taipei City (TW); Hong-Han SHUAI, New Taipei City (TW); De-Nian YANG, Taipei City (TW)

(21) Appl. No.: 16/202,047

(22) Filed: Nov. 27, 2018

(30) Foreign Application Priority Data
Oct. 31, 2018 (TW) 107138608

(51) Int. Cl. G06Q 30/02; G06Q 10/06; G06Q 30/06

(52) U.S. Cl. CPC G06Q 30/0204; G06Q 30/0631; G06Q 10/067

(57) ABSTRACT

A group marketing system, a group marketing device and a group marketing method thereof are provided. The group marketing system includes a data collecting device and a group marketing device. The data collecting device has a connection with the group marketing device and is configured to collect group data. The group marketing device is configured to store specific product customer data, receive the group data, generate group relation data according to the group data, generate group preference analysis data according to the group relation data and the specific product customer data, generate product data according to the group preference analysis data, and transmit the product data to an electronic device.

### PRIORITY

This application claims priority to Taiwan Patent Application No. 107138608 filed on Oct. 31, 2018, which is hereby incorporated by reference in its entirety.

### FIELD

The present invention relates to a group marketing system, a group marketing device and a group marketing method. More specifically, the group marketing system of the present invention is able to analyze a customer group's spending preferences and the association between the customer group and products to provide relevant product data.

### BACKGROUND

A variety of products or services (hereinafter the term “products” may be referred to as products, merchandises or services) are continuously increasing in the market with the development of technology and manufacture skills. Customers with different genders, different age levels, or different identities have different preferences for products. On the other hand, different products attract different customers. Merchants need to provide personalized product data for different customers in order to sell products more efficiently.

Conventional product marketing systems only focus on recommending products to an individual customer. Thus, the conventional product marketing systems merely analyze personal historical spending patterns, personal spending records, personal hobbies, personal interests, etc. and then provide personalized product recommendation for individual customer, or further generate personalized product recommendation information. However, when the consuming behaviors involve groups, the spending pattern and the desired products of the group are obviously different from those of the individual. Therefore, the conventional recommending systems do not satisfy with the demand of a customer group.

Accordingly, an urgent need exists in the art to provide a group marketing mechanism, which recommends products according to group relation.

### SUMMARY

Provided is a group marketing mechanism which generates product data suitable for a customer group by analyzing spending preferences of the customer group and the association between products and the group. Therefore, the group marketing mechanism efficiently selects the products which a customer group may desire to buy, and generates the product data relating to the selected products.

The disclosure includes a group marketing system, which comprises a data collecting device and a group marketing device. The data collecting device is connected to the group marketing device and configured to collect group data. The group marketing device is configured to store specific product customer data, receive the group data from the data collecting device, generate group relation data according to the group data, generate group preference analysis data according to the group relation data and the specific product customer data, generate product data according to group preference analysis data, and transmit the product data to an electronic data.

The disclosure further includes a group marketing method, which is adapted for a group marketing system. The group marketing system comprises a data collecting device and a group marketing device. The group marketing device is configured to store specific product customer data. The grouping marketing method comprises the following steps of: collecting, by the data collecting device, group data; receiving, by the group marketing device, the group data from the data collecting device; generating, by the group marketing device, group relation data according to the group data; generating, by the group marketing device, group preference analysis data according to the group relation data and the specific product customer data; generating, by the group marketing device, product data according to the group preference analysis data; and transmitting, by the group marketing device, the product data to an electronic device.

The disclosure additionally includes a group marketing device, which is adapted for a group marketing system. The group marketing device comprises a processor, a storage, and a transmission interface. The transmission interface is configured to connect to a data collecting device and an electronic device. The storage is configured to store specific product customer data. The processor is configured to receive group data from the data collecting device, generate group relation data according to the group data, generate group preference analysis data according to the group relation data and the specific product customer data, generate product data according to the group preference analysis data, and transmit the product data to the electronic device.

The detailed technology and preferred embodiments implemented of the present invention are described in the following paragraphs accompanying the appended drawings for people skilled in this field to well appreciate the features of the claimed invention.

### BRIEF DESCRIPTION OF THE DRAWINGS

FIG. 1A is a schematic view of an operating condition of a group marketing system of the first embodiment of the present invention;

FIG. 1B is a schematic view of block diagrams of a group marketing device, a data collecting device and an electronic device of the first embodiment of the present invention;

FIG. 2 is a schematic view of group data, group relation data, specific product customer data, group preference analysis data, and product data of the present invention;

FIG. 3 is a schematic view of heterogeneous relation model of the present invention; and

FIG. 4 is a flow diagram of a group marketing method of the fourth embodiment of the present invention.

### DETAILED DESCRIPTION

In the following description, the present invention will be explained with reference to certain example embodiments thereof. However, these example embodiments are not intended to limit the present invention to any specific example, embodiment, environment, applications or particular implementations described in these example embodiments.

Therefore, description of these example embodiments is only for purpose of illustration rather than to limit the present invention, and the scope of this application shall be governed by the claims.

It should be appreciated that, in the following embodiments and the attached drawings, elements unrelated to the present invention are omitted from depiction; and dimensional relationships among individual elements in the attached drawings are provided only for ease of understanding, but not to limit the actual scale.

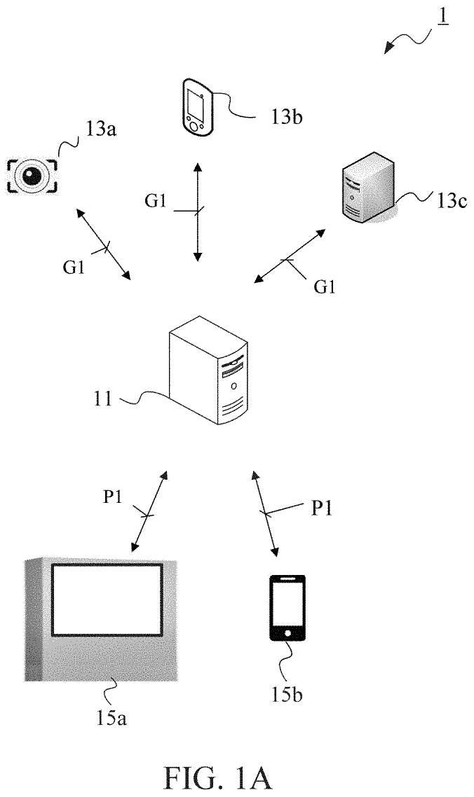

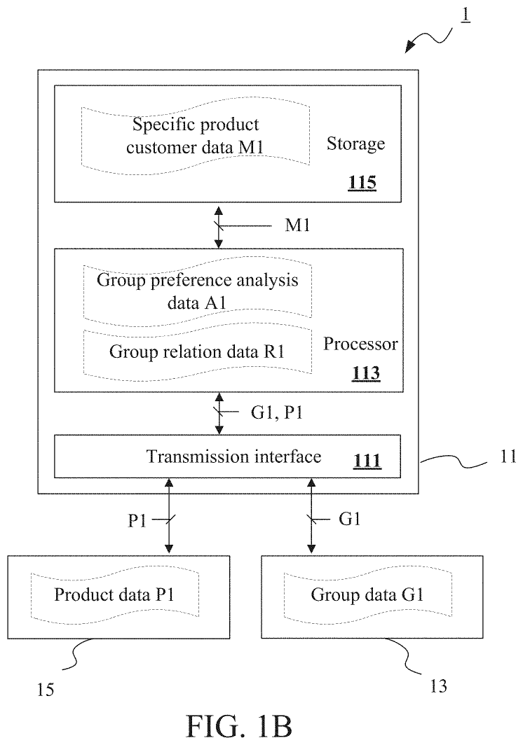

Please refer to FIG. 1A and FIG. 1B for a first embodiment of the present invention. FIG. 1A is a schematic view of an operating condition of a group marketing system 1 of the present invention. FIG. 1B is a schematic view of block diagrams of a group marketing device 11, a data collecting device 13 and an electronic device 15 of the present invention.

The group marketing system 1 comprises the group marketing device 11 and the data collecting device 13. The group marketing device 11 comprises a transmission interface 111, a processor 113 and a storage 115, wherein the processor 113 is electrically connected to the transmission interface 111 and the storage 115. The group marketing device 11 is connected to the data collecting device 13 and the electronic device 15 via the transmission interface 111. It shall be noted that the data collecting device 13 may be one of data collecting devices 13a, 13b, and 13c in FIG. 1A (e.g., a camera, a mobile device, or a data server, but it is not limited), and the electronic device 15 may be one of electronic devices 15a and 15b (e.g., a digital signage, kiosk, a display device with processor, or a mobile device, but not limited thereto). The operation of the group marketing system 1 is described in the following.

Firstly, the data collecting device 13 is configured to collect group data G1. The storage 115 of the group marketing device 11 is configured to store specific product customer data M1. The processor 113 of the group marketing device 11 is configured to receive the group data G1 from the data collecting device 13 via the transmission interface 111. It shall be noted that the data transmission connection between the data collecting device 13 and the group marketing device 11 may be a physical connection (e.g., a bus), a wired network connection (e.g., the optical fiber network), or a wireless network connection (e.g., the Wi-Fi or Bluetooth).

Next, the processor 113 of the group marketing device 11 is configured to generate group relation data R1 according to the group data G1, generate group preference analysis data A1 according to the group relation data R1 and specific product customer data M1, and generate product data P1 according to the group preference analysis data A1. Afterwards, the processor 113 of the group marketing device 11 is configured to transmit the product data P1 to the electronic device 15 via transmission interface 111.

It shall be noted that the data collecting device 13 may obtain the group data G1 by capturing or photographing passers-by, by collecting, analyzing and establishing from a variety of sources, such as members' spending record, customer survey, or by analyzing and establishing via big data, but not limited thereto. In one better implementation, data collecting device 13 is an image capturing device, and the group data G1 includes an image. Subsequently, after analyzing the image, the processor 113 of the group marketing device 11 generates the group relation data R1 according to the analyzed image result.

It shall be noted that, in the first embodiment, the electronic device 15 maybe one of a user device, an image playing device, an audio playing device and a video playing device, but not limited thereto. In one implementation, the group marketing device 11 may transmit product data P1 to a plurality of electronic devices which are same type or different type (e.g., electronic devices 15a and 15b).

It shall be noted that the group marketing device 11 may be a server, a cloud computing system, etc., but not limited thereto. The transmission interface 111 may include various internal connection interfaces (e.g., flat cables with different function) to enable a plurality of elements disposed in the same device to be connected with each other and to transmit data. In some embodiment, transmission interface 111 may also include various input/output interfaces to enable a plurality of elements disposed in different devices to be connected with each other and to transmit data. The input/output interfaces may include various wireless communication interface (e.g., Bluetooth interface, Wi-Fi interface, mobile communication network interface, but not limited thereto). The input/output interfaces may include wired communication interfaces (e.g., optical fiber network, but not limited thereto).

The processor 113 may include a variety of microprocessors or microcontroller. The microprocessor or the microcontroller is a programmable special integrated circuit, which is capable to perform functions of processing, storing, inputting/outputting, etc., to receive and process a variety of coding commands to execute a variety of logic processing and mathematical processing, and to output the corresponding processing result.

The storage 115 may comprise a primary memory (also called a main memory or an internal memory) for directly connected to the processor 113. The processor 113 can read instruction sets stored in the primary memory and execute these instruction sets if needed. The storage 115 may further comprise a secondary memory (also called an external memory or an auxiliary memory), and the secondary memory connects to the processor 113 via an I/O channel of the memory instead of directly connecting to the processor 113 and uses a data buffer to transmit data to the primary memory. The secondary memory may for example be any of various hard disks, optical disks or the like. The storage 115 may also comprise a third-level memory, i.e., a storage device that can be directly inserted into or pulled out from a computer, e.g., a mobile disk.

The second embodiment of the present invention is an extension of the first embodiment. The second embodiment has all of elements and functions in the first embodiment. Therefore, the difference therebetween is described only in the following, and the features of the first embodiment will not be repeatedly described. Specifically, the second embodiment includes a plurality of implementations, which may exist independently or together.

In one implementation, the group marketing device 11 is further configured to store rules of the group features (not shown). The group marketing device 11 is further configured to generate the group relation data R1 according to the rules of the group features and the group data G1. For example, the rules of the group features may include determination factors such as appearance, clothing, age, age gap, body movement, social interaction condition, answers of questionnaire. The group appearance, clothing, age, age gap, body movement, etc. may be obtained by analyzing images, and the social interaction condition may be obtained by analyzing spending record, customer questionnaire, social community data, etc. In other words. the group marketing device 11 may use the rules of the group features to identify a target group, determine the relation among the target group in the group data G1, and exclude the people irrelevant to the target group in the group data G1.

In one implementation, the group marketing device 11 is further configured to store a preference related model (not shown). The group marketing device 11 is further configured to input the group relation R1 and the specific product customer data M1 into the preference related model to generate the group preference analysis data A1. The group preference analysis data A1 includes at least one of a value of product diversity, a value of user diversity, a value of social familiarity, and a value of group preference on specific product.

For example, the value of product diversity may be a quantized value weighted and calculated from factors such as product types, product amounts, locations. The user variety value may be a quantized value weighted and calculated from factors such as customer gender, customer age levels. The value of social familiarity may be a quantized value weighted and calculated from factors such as intimacy level or familiarity level among customers. The value of group preference on specific product may be a quantized value weighted and calculated from factors such as preference levels of costumers toward products, times of purchasing. Each value may be regarded as being calculated with different weight values and may be added or have proportional influence relation with each other. Therefore, according to the preference related model, the group relation data R1 and the specific product customer data M1, the group marketing device 11 is capable to generate the group preference analysis data A1 which is more suitable to group need.

In an implementation, the group marketing device 11 is further configured to store a heterogeneous relation model (not shown). The group marketing device 11 is further configured to input the group preference analysis data A1, the specific product customer data M1, the group relation data R1, and product description and sales data (not shown) into the heterogeneous relation model to generate the product data P1. Moreover, the heterogeneous relation mode further includes at least one of a weight of product difference, a weight of user difference, and a weight of purchasing preference.

For example, the group marketing device 11 analyzes the group preference analysis data A1, the specific product customer data M1, the group relation data R1, and the product description and sales data as a whole through the heterogeneous relation model to recommend the suitable product data P1 for a group. The weight of product difference, the weight of user difference, and the weight of purchasing preference may be set by collecting statistic of sales records possessed by merchants.

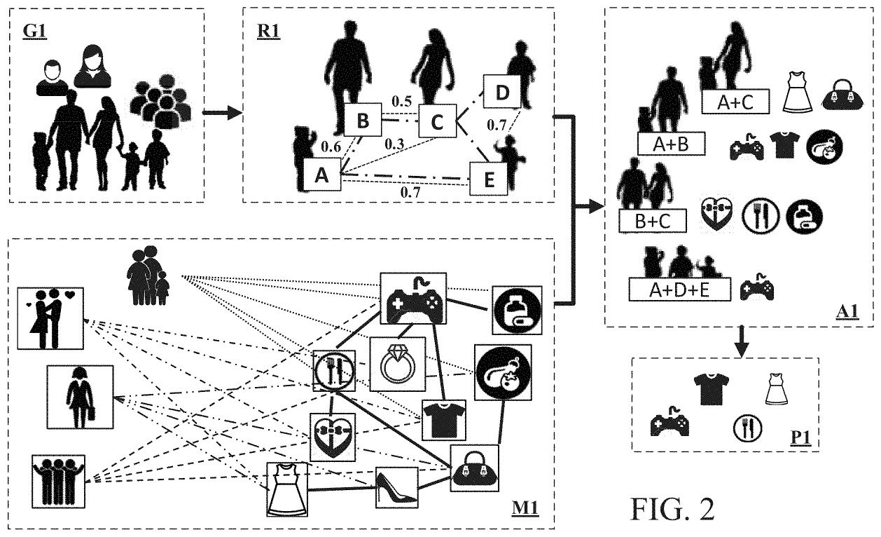

To make the aforesaid descriptions be more easily appreciated, the third embodiment is used as an exemplary example for further explanation. The third embodiment includes all the elements of the first and second embodiments, and can execute all the functions of the first and second embodiments. Please refer to FIG. 1A, FIG. 1B and FIG. 2, wherein FIG. 2 is a schematic view of the group data G1, the group relation data R1, the specific product customer data M1, the group preference analysis data A1 and the product data P1. Each content of data and each relation between data are explained in detail as follows.

First, the specific product customer data M1 is stored in the group marketing device 11. The specific product customer data M1 records details of the corresponding relation between products and groups. More specifically, different groups have specific spending preferences. For example, people in family status have preferences for ingredients, clothing, medicine, etc.; people in couple status (or romantic status) have preferences for accessories, gifts, restaurants, clothing, etc.; people in single status have preferences for clothing, famous brand things; people in friend status have preferences for restaurants, entertainments, etc. In other words, merchants may associate products with potential groups according to groups' preferences and each product feature. There may be a weight value between a product and a group and there may be a weight value between a product and another product in order to represent the association therebetween. The aforesaid example is merely used for explanation but is not used to limit the present invention.

On the other hand, the group data G1 is obtained by the data collecting device 13. In the third embodiment, the data collecting device 13 gathers the group data G1 in the way of photography and transmits the group data G1 to the group marketing device 11. The group data G1 includes at least one target customer group, e.g., the five people hand in hand in the bottom of group data G1. It shall be noted that the group data G1 of the third embodiment is one of a picture or a video, but it is not limited. In an implementation, the date collecting device 13 may preliminarily analyze a target group in the crowd in the group data G1, and then provide the group marketing device 11 with the processed group data G1.

Next, the group marketing device 11 generates the group relation data R1 according to the group data G1, after receiving the group data G1. More specifically, the group marketing device 11 identifies the target customer group from a photograph or a video (e.g., the five people hand in hand in the bottom of the group data G1), and then sets weight values (e.g., relation weight value, intimacy level weight value or similarity weight value) among the five people in the group relation data R1. For example, the weight value between A and B is 0.6, the weight value between A and C is 0.3, the weight value between A and D is not considered here, and the weight value between A and E is 0.7.

Subsequently, the group marketing device 11 may be configured to generate the group preference analysis data A1 according to the group relation data R1 and the specific product customer data M1. In details, according to the group relation data R1, the customer group can be noticed as a family, which includes five people A, B, C, D, and E. As for the aforesaid five people, the relation combinations may include at least one sub-relation combination such as a parent-kid combination (e.g., A+B, or A+C), a couple combination (e.g., B+C), or a friend combination (e.g., A+D+E).

According to the specific product customer data M1, each sub-relation combination may indicate products which each sub-relation group may purchase. For example, as to the parent-kid combination (A+B), it may be interested in entertainments, restaurants, etc.; as to the couple combination (B+C), it may be interested in gifts, restaurants, etc. Therefore, the group marketing device 11 may search out products which the sub-relation combination of the group may purchase, and generate the product data P1 accordingly.

In other words, different relation combinations may be more interested in specific products. Thus, the group marketing device 11 may generate the product data P1 according to the group preference analysis data A1, and transmit the product data P1 to the electronic device 15 for providing the specific product data to the group.

In an implementation, the group marketing device 11 generate the product data P1 from the preferred products of each relation combination by the mean of a union of sets and/or an intersection of sets. For example, the group marketing device 11 may make the product data P1 include at least one relevant product information according to the products which appear more or belong to the same type (e.g., entertainment or clothing) among different sub-relations.

In an implementation, the group marketing device 11 sets weight values for each sub-relation combination and preferred products of each sub-relation combination, and generates the product data P1 by the calculation of weight values. For example, different weight values may be set from different people, different group relation combinations, different product items, different time, different locations, social relationship, purchasing records, etc., and the product data P1 is generated by summing the weight values.

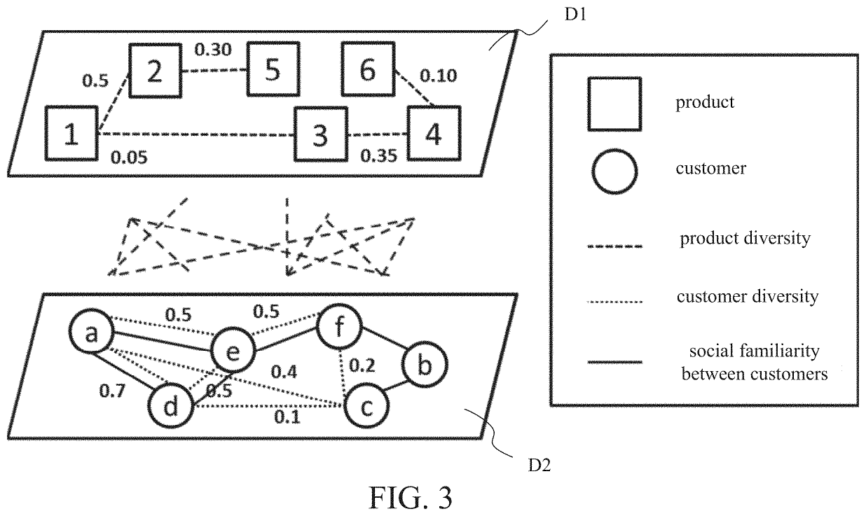

Please refer to the FIG. 3, which depicts a schematic view of a heterogeneous relation model (such as the mentioned heterogeneous relation model in the second embodiment). Specifically, FIG. 3 is used to further detail the operation of the heterogeneous relation model. The heterogeneous relation model includes a product dimension D1 and a customer group dimension D2. The product dimension D1 is used to record each product (e.g., products 1-6), and there may be a correlative weight value between products. The customer group dimension D2 is used to record each customer (e.g., customers a-f), and there may be a correlative weight value between customers.

The group preference analysis data A1, the specific product customer data M1, the group relation data R1, and the product description and sales data (not shown) may be inputted into the heterogeneous relation model. According to the association calculation of the association-featured weight values between products, the association-featured weight values between customers, and the association-featured weight values between each product and each customer, the group marketing device 11 may generate the product data P1 which is the most suitable for a group.

It shall be noted that the product description and sales data is a calculation reference basis of product diversity weight and the user diversity weight, and the product description and sales data is used to establish the largest set product set which find the most suitable products for the group.

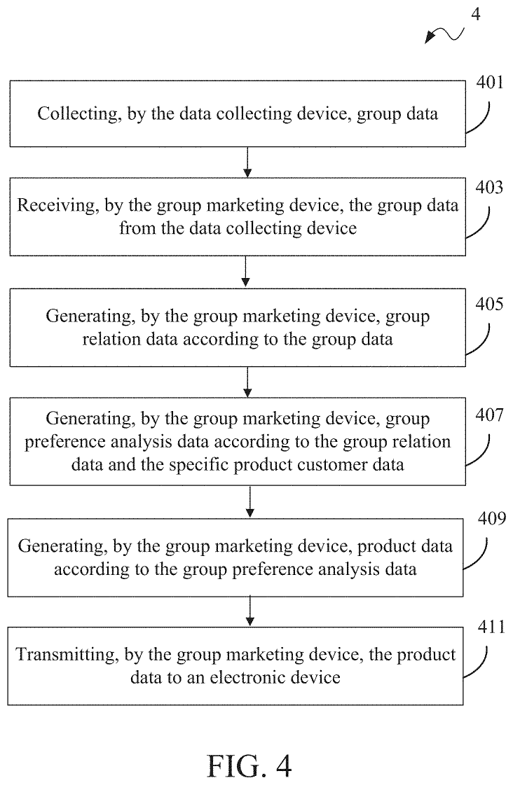

Please refer to FIG. 4 for the fourth embodiment of the present invention, and FIG. 4 is a flow diagram of a group marketing method 4. The group marketing method 4 is adapted for a group marketing system (e.g., the group marketing system 1 of the first embodiment). The group marketing system comprises a data collecting device and a group marketing device. The group marketing device stores specific product customer data. The group marketing device is connected to the data collecting device.

The group marketing method 4 comprises the following steps of: in step 401, collecting, by the data collecting device, group data; in step 403, receiving, by the group marketing device, the group data from the data collecting device; in step 405, generating, by the group marketing device, group relation data according to the group data; in step 407, generating, by the group marketing device, group preference analysis data according to the group relation data and the specific product customer data; in step 409, generating, by the group marketing device, product data according to the group preference analysis data; and in step 411, transmitting, by the group marketing device, the product data to an electronic device.

In an implementation, the data collecting device is an image capturing device, and the group data includes an image.

In an implementation, the data collecting device is further configured to store a group characteristics rule. The group marketing method further comprises the following step of:

generating, by the group marketing device, the group relation data according to the rules of the group features and the group data.

In an implementation, the data collecting device is further configured to store a preference related model. The group marketing method further comprises the following step of: generating, by the group marketing device, the group preference analysis data by inputting the group relation data and the specific product customer data into the preference related model. The group preference analysis data includes at least one of a value of product diversity, a value of user diversity, a value of social familiarity and a value of group preference on specific product.

In an implementation, the data collecting device is further configured to store a heterogeneous relation model. The group marketing method further comprises the following step of: generating, by the group marketing device, the product data by inputting the group preference analysis data, the specific product customer data, the group relation data, and product description and sales data into the heterogeneous relation model. The heterogeneous relation model includes at least one of a weight of product difference, a weight of user difference, and a weight of purchasing preference.

In addition to the aforesaid steps, group marketing method of the present invention can also execute all the operations described in the aforesaid embodiments and have all the corresponding functions, and how this embodiment executes these operations and has these functions based on the aforesaid embodiments shall be readily appreciated by those of ordinary skill in the art, and thus will not be further described herein.

In summary, the group marketing system and the method thereof of the present invention analyze the spending preference of each group and the relations between groups, and generate the product data suitable for group accordingly. Therefore, in comparison to the prior arts, the group marketing system and the method thereof of the present invention is more suitable for group to recommend products.

The above disclosure is related to the detailed technical contents and inventive features thereof. People of ordinary skill in the field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A group marketing system, comprising:
a data collecting device, being configured to collect group data; and
a group marketing device, connected to the data collecting device, being configured to store specific product customer data and execute the following operations of:
receiving the group data from the data collecting device;
generating group relation data according to the group data;
generating group preference analysis data according to the group relation data and the specific product customer data; and
generating product data according to the group preference analysis data; and
transmitting the product data to an electronic device.

2. The group marketing system of claim 1, wherein the data collecting device is an image capturing device and the group data includes an image.

3. The group marketing system of claim 1, wherein the electronic device is one of a user device, an image playing device, an audio playing device and a video playing device.

4. The group marketing system of claim 1, wherein the group marketing device is further configured to store rules of the group features and generate the group relation data according to the group data and the rules of the group features.

5. The group marketing system of claim 1, wherein the group marketing device is further configured to store a preference related model and generate the group preference analysis data by inputting the group relation data and the specific product customer data into the preference related model, and the group preference analysis data includes at least one of a value of product diversity, a value of user diversity, a value of social familiarity and a value of group preference on specific product.

6. The group marketing system of claim 1, wherein the group marketing device is further configured to store a heterogeneous relation model, and generate the product data by inputting the group preference analysis data, the specific product customer data, the group relation data and product description and sales data into the heterogeneous relation model.

7. The group marketing system of claim 6, wherein the heterogeneous relation model includes at least one of a weight of product difference, a weight of user difference, and a weight of purchasing preference.

8. A group marketing device, comprising:
a storage, configured to store specific product customer data;
a transmission interface, configured to connect to a data collecting device; and
a processor, electrically connected to the storage and the transmission interface and configured to execute the following operations of:
receiving, via the transmitting interface, group data from the data collecting device;
generating group relation data according to the group data
generating group preference analysis data according to the group relation data and the specific product customer data;
generating product data according to the group preference analysis data; and
transmitting, via the transmitting interface, the product data to an electronic device.

9. The group marketing device of claim 8, wherein the data collecting device is an image capturing device and the group data include an image.

10. The group marketing device of claim 8, wherein the storage is further configured to store rules of the group features, and the processor is further configured to generate the group relation data according to the group data and the rules of the group features.

11. The group marketing device of claim 8, wherein the storage is further configured to store a preference related model, and the processor is further configured to generate the group preference analysis data by inputting the group relation data and the specific product customer data into the preference related model, wherein the group preference analysis data includes at least one of a value of product diversity, a value of user diversity, a value of social familiarity and a value of group preference on specific product.

12. The group marketing device of claim 8, wherein the storage is further configured to store a heterogeneous relation model, and the processor is further configured to generate the product data by inputting the group preference analysis data, the specific product customer data, the group relation data and product description and sales data into the heterogeneous relation model.

13. The group marketing device of claim 12, wherein the heterogeneous relation model includes at least one of a weight of product difference, a weight of user difference, and a weight of purchasing preference.

14. A group marketing method for a grouping marketing system, the grouping marketing system including a data collecting device and a group marketing device, the group marketing device storing specific product customer data and being connected to the data collecting device, the group marketing method comprising:
collecting, by the data collecting device, group data;
receiving, by the group marketing device, the group data from the data collecting device;
generating, by the group marketing device, group relation data according to the group data;
generating, by the group marketing device, group preference analysis data according to the group relation data and the specific product customer data;
generating, by the group marketing device, product data according to the group preference analysis data; and
transmitting, by the group marketing device, the product data to an electronic device.

15. The group marketing method of claim 14, wherein the data collecting device is an image capturing device and the group data includes an image.

16. The group marketing method of claim 14, wherein the group marketing device further stores rules of the group features, and the group marketing method further comprises the following step:
generating, by the group marketing device, the group relation data according to the group data and the rules of the group features.

17. The group marketing method of claim 14, wherein the group marketing device further stores a preference related model, and the group marketing method further comprises:
generating, by the group marketing device, the group preference analysis data by inputting the group relation data and the specific product customer data into the preference related model, wherein the group preference analysis data includes at least one of a value of product diversity, a value of user diversity, a value of social familiarity and a value of group preference on specific product.

18. The group marketing method of claim 14, wherein the group marketing device further stores a heterogeneous relation model, and the group marketing method further comprises the following step:
generating, by the group marketing device, the product data by inputting the group preference analysis data, the specific product customer data, the group relation data and product description and sales data into the heterogeneous relation model.

19. The group marketing method of claim 14, wherein the heterogeneous relation model includes at least one of a weight of product difference, a weight of user difference, and a weight of purchasing preference.
